(19) United States
(12) Patent Application Publication
(10) Pub. No.: US 2022/0363809 A1
(43) Pub. Date: Nov. 17, 2022

(54) POLYMERIZABLE COMPOSITIONS FOR PREPARING POLYISOCYANURATE-BASED PLASTICS HAVING EXTENDED WORKLIFE

(71) Applicant: Covestro Intellectual Property GmbH & Co. KG, Leverkusen (DE)

(72) Inventors: Richard Daniel Matthias Meisenheimer, Köln (DE); Paul Heinz, Leverkusen (DE); Dirk Achten, Leverkusen (DE); Florian Golling, Düsseldorf (DE); Hans-Josef Laas, Odenthal (DE); Dieter Mager, Leverkusen (DE)

(21) Appl. No.: 17/619,084

(22) PCT Filed: Jul. 1, 2020
(86) PCT No.: PCT/EP2020/068438

§ 371 Date: Dec. 14, 2021

(30) Foreign Application Priority Data
Jul. 8, 2019 (EP) 19184858.9

(51) Int. Cl. C08G 18/79; C08G 18/73; C08G 18/75; C08G 18/32; C08G 18/22; C08G 18/09; C08G 18/72; C09D 175/04; C09J 175/04

(52) U.S. Cl. CPC C08G 18/792; C08G 18/73; C08G 18/755; C08G 18/3206; C08G 18/225; C08G 18/092; C08G 18/722; C09D 175/04; C09J 175/04; C08G 2115/02

(57) ABSTRACT

The invention relates to polymerizable compositions that are suitable for preparing polyisocyanurate-based plastics and have an extended worklife as compared to the compositions conventionally used for this purpose.

The present invention relates to polymerizable compositions suitable for producing polyisocyanurate plastics and having an extended pot life compared to the compositions conventionally employed therefor.

WO 2016/170059 for example describes the production of polyisocyanurate plastics. It has been found that these plastics are particularly suitable as a polymer matrix for the production of fiber composite materials (WO 2017/191216).

An often employed process for continuous production of fiber composite materials is pultrusion. This comprises pulling a fiber through an immersion bath filled with a polymerizable composition and subsequently curing in a heated profile. The polymerizable composition forms a polymer matrix in which the fiber has been embedded. It is important here that the polymerizable composition has a very low reactivity at room temperature in order that the viscosity of the polymerizable composition in the immersion bath remains low enough to allow use for as long as possible. The period from providing the polymerizable composition until reaching a viscosity unacceptably high for the relevant application is also known to those skilled in the art as the pot life. A long pot life is desirable in other fields of application too.

There are combinations of catalysts and aliphatic polyisocyanates which remain liquid for a relatively long time at room temperature while nevertheless curing rapidly to afford polyisocyanurate plastics at elevated temperature and are therefore suitable in principle for pultrusion processes (WO 2018/054776). However, it has been found during practical testing of these systems that the achievable pot lives were subject to considerable variation and were in some cases too low for commercial use.

Investigation of this phenomenon has surprisingly shown that the pot life of such polymerizable compositions may be substantially extended by increasing the proportion of carbon dioxide dissolved in the polymerizable composition. Those skilled in the art thus have at their disposal a simple means to extend the pot life of these compositions without impairing reactivity at elevated temperatures.

In a first embodiment the present invention therefore provides a polymerizable composition having a molar ratio of isocyanate groups to isocyanate-reactive groups of at least 1.5:1.0 containing
a) a polyisocyanate composition A containing at least 1% by weight of isocyanate groups;
b) at least one trimerization catalyst B which is a carboxylate; and
c) at least 150 ppm of CO₂ based on the total amount of the liquid constituent of the polymerizable composition.

A “polymerizable composition” is a composition which contains at least the abovementioned components and by crosslinking of the functional groups of the components present therein may be cured to afford a polymer. This polymer necessarily contains functional groups formed by the crosslinking of isocyanate groups with one another. These are preferably selected from the group consisting of isocyanurate, biuret, uretdione, iminooxadiazinedione and oxadiazinetrione structures. The polymer particularly preferably contains isocyanurate groups or oxadiazinetrione groups and for simplicity is therefore also referred to in the present application as “isocyanurate plastic”. To bring about formation of these groups it is essential to the invention that the polymerizable composition contains a molar excess of isocyanate groups to isocyanate-reactive groups since otherwise—depending on the type and amount of the isocyanate-reactive groups present—urethane, amino or else urea groups are formed in undesirably high proportions or even exclusively. In a preferred embodiment of the present invention the molar ratio of isocyanate groups to isocyanate-reactive groups is at least 2:1, more preferably at least 3:1 and yet more preferably at least 5:1. “Isocyanate-reactive groups” in the context of the present application are hydroxyl, thiol and amino groups. The amino groups may be primary and secondary amino groups.

Taking account of the abovementioned limitations the polymerizable composition may contain customary additives. These are preferably pigments, fillers, antioxidants, flame retardants, demolding agents and UV stabilizers.

### Polyisocyanate Composition A

The term “polyisocyanate composition A” refers to all compounds containing at least one free isocyanate group present in the polymerizable composition according to the invention.

The polyisocyanate composition A has an isocyanate group content of at least 1% by weight, preferably at least 5% by weight, more preferably at least 10% by weight and yet more preferably at least 15% by weight based on its total weight.

However, to achieve curing of the polymerizable composition it is essential to the invention that the polyisocyanate composition A consists of polyisocyanates as defined hereinbelow to an extent of at least 70% by weight, preferably to an extent of at least 80% by weight and most preferably to an extent of at least 90% by weight.

In the present application the term “polyisocyanate” is to be understood as meaning any compound comprising on average at least 1.8, preferably at least 2.0 and particularly preferably at least 2.1 isocyanate groups. By contrast “monoisocyanate” is to be understood as meaning a compound having on average not more than 1.6 isocyanate groups per molecule, in particular only having one isocyanate group per molecule.

In the present application the term “polyisocyanates” refers to both monomeric and/or oligomeric polyisocyanates. For the understanding of many aspects of the invention, however, it is important to distinguish between monomeric diisocyanates and oligomeric polyisocyanates. Where reference is made in the present application to “oligomeric polyisocyanates”, this means polyisocyanates formed from at least two monomeric diisocyanate molecules, i.e. compounds that constitute or contain a reaction product formed from at least two monomeric diisocyanate molecules.

### Oligomeric Isocyanates

Oligomeric isocyanates are obtained by “modification” of a monomeric isocyanate. “Modification” is to be understood as meaning the reaction of monomeric isocyanates to afford oligomeric isocyanates having a uretdione, isocyanurate, allophanate, biuret, iminooxadiazinedione and/or oxadiazinetrione structure. Preferably employed as reactants for the production of oligomeric isocyanates are diisocyanates.

Thus for example hexamethylene diisocyanate (HDI) is a “monomeric diisocyanate” since it contains two isocyanate groups and is not a reaction product of at least two polyisocyanate molecules:

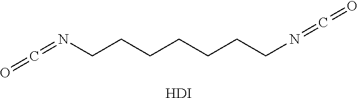

By contrast, reaction products of at least two HDI molecules which still have at least two isocyanate groups are “oligomeric polyisocyanates” in the context of the invention. Representatives of such “oligomeric polyisocyanates” are, proceeding from monomeric HDI, for example, HDI isocyanurate and HDI biuret, each of which are formed from three monomeric HDI units:

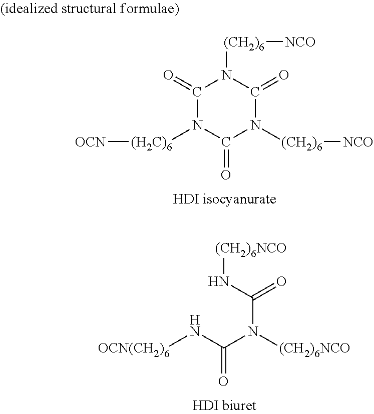

Production processes for oligomeric polyisocyanates having a uretdione, isocyanurate, allophanate, biuret, iminooxadiazinedione and/or oxadiazinetrione structure are described, for example, in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299.

It is particularly preferable when the monomeric isocyanates defined hereinbelow in the present application are used as the starting materials for modification.

The polymerizable composition according to the invention may contain oligomeric and polymeric polyisocyanates in any desired mixing ratios. For reasons of industrial safety, preference is in principle given to polymerizable compositions whose polyisocyanate component, i.e. the entirety of all polyisocyanates present in said composition, consists of oligomeric polyisocyanates to an extent of at least 90% by weight, preferably at least 95% by weight and more preferably at least 98% by weight. However, if desired, for example for reducing the viscosity of the polymerizable composition, the polyisocyanate component may also contain up to 20% by weight or preferably up to 50% by weight of monomeric polyisocyanates.

### Isocyanates Having Aliphatically Bonded Isocyanate Groups

In an isocyanate having aliphatically bonded isocyanate groups all isocyanate groups are bonded to a carbon atom that is part of an open carbon chain. This may be unsaturated at one or more sites. The aliphatically bonded isocyanate group or—in the case of polyisocyanates—the aliphatically bonded isocyanate groups are preferably bonded at the terminal carbon atoms of the carbon chain.

Polyisocyanates having aliphatically bonded isocyanate groups that are particularly suitable according to the invention are 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane and 1,10-diisocyanatodecane.

### Isocyanates Having Cycloaliphatically Bonded Isocyanate Groups

In an isocyanate having cycloaliphatically bonded isocyanate groups all isocyanate groups are bonded to carbon atoms which are part of a closed ring of carbon atoms. This ring may be unsaturated at one or more sites provided that it does not attain aromatic character as a result of the presence of double bonds.

Polyisocyanates having cycloaliphatically bonded isocyanate groups that are particularly suitable according to the invention are 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane and 1,3-dimethyl-5,7-diisocyanatoadamantane.

### Isocyanates Having Araliphatically Bonded Isocyanate Groups

In an isocyanate having araliphatically bonded isocyanate groups all isocyanate groups are bonded to methylene radicals which are in turn bonded to an aromatic ring.

Polyisocyanates having araliphatically bonded isocyanate groups that are particularly suitable according to the invention are 1,3- and 1,4-bis(isocyanatomethyl)benzene (xyxlylene diisocyanate; XDI), 1,3- and 1,4-bis(1-isocyanato-1-methylethyl)benzene (TMXDI) and bis(4-(1-isocyanato-1-methylethyl)phenyl) carbonate.

### Isocyanate Having an Aromatically Bonded Isocyanate Group

In an isocyanate having aromatically bonded isocyanate groups all isocyanate groups are bonded directly to carbon atoms which are part of an aromatic ring.

Isocyanates having aromatically bonded isocyanate groups that are particularly suitable according to the invention are 2,4- and 2,6-diisocyanatotoluene (TDI), 2,4′- and 4,4′-diisocyanatodiphenylmethane (MDI) and 1,5-diisocyanatonaphthalene.

### Monoisocyanates

Monoisocyanates particularly suitable according to the invention are preferably selected from the group consisting of n-butyl isocyanate, n-amyl isocyanate, n-hexyl isocyanate, n-heptyl isocyanate, n-octyl isocyanate, undecyl isocyanate, dodecyl isocyanate, tetradecyl isocyanate, cetyl isocyanate, stearyl isocyanate, cyclopentyl isocyanate, cyclohexyl isocyanate, 3- or 4-methylcyclohexyl isocyanate, methylbenzyl isocyanate, methyl isocyanate, (trimethylsilyl) isocyanate, 1-naphtyl isocyanate, 3-methyl-2-butyl isocyanate, 1-(4-methoxyphenyl)ethyl isocyanate, 1-(3-methoxyphenyl)ethyl isocyanate, 1-phenylpropyl isocyanate, 2-octyl isocyanate, 2-heptyl isocyanate, 4-butyl-2-methylphenyl isocyanate, 3-(triethoxysilyl)propyl isocyanate, 2-benzyloxycyclohexyl isocyanate, 1-(4-chlorophenyl)ethyl isocyanate, 2-nonyl isocyanate, 1-(4-bromophenyl)ethyl isocyanate, 2,1,3-benzothiadiazol-4-yl isocyanate, p-phenylazophenyl isocyanate, phenyl isocyanate, ethyl isocyanate, chlorosulfonyl isocyanate, allyl isocyanate, benzyl isocyanate, propyl isocyanate, isoproyl isocyanate, furfuryl isocyanate, propyl isocyanate, octadecyl isocyanate, trichloroacetyl isocyanate, benzoyl isocyanate, phenethyl isocyanate, p-tolyl isocyanate, o-tolyl isocyanate, m-tolylisocyanat, 3,4-dimethoxyphenyl isocyanate, 2,4-dimethoxyphenyl isocyanate, 3,5-dimethoxyphenyl isocyanate, 2,5-dimethoxyphenyl isocyanate, tert-butyl isocyanate, 3,5-dimethylphenyl isocyanate, 2,6-dimethylphenyl isocyanate, 4-ethylphenyl isocyanate, 4-methylbenzyl isocyanate, 2-methylbenzyl isocyanate, 3-methylbenzyl isocyanate, 4-methoxyphenyl isocyanate, 4-tert-butylphenyl isocyanate, 2-methoxyphenyl isocyanate, 3,4,5-trimethoxyphenyl isocyanate, 2,4-dimethoxybenzyl isocyanate, 4-phenylbutyl isocyanate, 4-ethylphenethyl isocyanate, 4-methoxybenzyl isocyanate, benzenesulfonyl isocyanate, 2-methoxybenzyl isocyanate, 3-ethoxyphenyl isocyanate, 3-methoxybenzyl isocyanate, 2,2-diphenylethyl isocyanate, 1,1,3,3-tetramethylbutyl isocyanate, 2-ethylhexyl isocyanate, 4-biphenylyl isocyanate, 3-phenylpropyl isocyanate, 2,3-dimethoxyphenethyl isocyanate, decyl isocyanate, cyclohexanemethyl isocyanate, 3,4-methylendioxyphenethyl isocyanate, 3,4-dimethoxyphenethyl isocyanate, 5-indanyl isocyanate, cycloheptyl isocyanate, 2-phenylcyclopropyl isocyanate, 1-cyclohexylethyl isocyanate, 4-nitrophenyl isocyanate, 1-adamantyl isocyanate, 2-nitrophenyl isocyanate, 3-nitrophenyl isocyanate, pyridine-3-isocyanate, chloroacetyl isocyanate, 2,6-diisopropylphenyl isocyanate, hexadecyl isocyanate, 4-acetylphenyl isocyanate, 4-phenoxyphenyl isocyanate, 4-pentylphenyl isocyanate, 3-phenoxyphenyl isocyanate, p-toluenesulfonyl isocyanate, 2-chloroethyl isocyanate, 2-bromophenyl isocyanate, 3-chlorophenyl isocyanate, 2-chlorophenyl isocyanate, 4-bromophenyl isocyanate, 4-chlorophenyl isocyanate, 2-naphthyl isocyanate, 4-fluorophenyl isocyanate, 2-bromoethyl isocyanate, 4-cyanophenyl isocyanate, 3,4-dichlorophenyl isocyanate, 2,3,4-trifluorophenyl isocyanate, 3-cyanophenyl isocyanate, 2,6-dichlorophenyl isocyanate, diethoxyphosphinyl isocyanate, 2,4-dichlorophenyl isocyanate, 3,3,4,4,5,5,6,6,7,7,8,8,9,9,10,10,10-heptadecafluorodecyl isocyanate, 4-fluorobenzyl isocyanate, 2-fluorophenyl isocyanate, 3-chloropropyl isocyanate, 3-fluorophenyl isocyanate, 4-iodophenyl isocyanate, 3,5-dichlorophenyl isocyanate, 4-chlorobenzenesulfonyl isocyanate, 2,4,6-tribromophenyl isocyanate, 2-iodophenyl isocyanate, 3,4-difluorophenyl isocyanate, 3-bromophenyl isocyanate, 2,4-dichlorobenzyl isocyanate, 2,5-difluorophenyl isocyanate, 2-benzylphenyl isocyanate, 2-fluorobenzyl isocyanate, 4-fluorophenethyl isocyanate, pentafluorophenyl isocyanate, 2,4-dichlorophenethyl isocyanate, 4-chlorobenzyl isocyanate, diphenylmethyl isocyanate, tributyltin isocyanate, 2-chlorobenzenesulfonyl isocyanate, 2-chlorobenzyl isocyanate, 3,3-diphenylpropyl isocyanate, 3,4,5-trimethoxybenzyl isocyanate, 3-chlorophenethyl isocyanate, 3-fluorobenzyl isocyanate, 2,6-difluorophenyl isocyanate, 3-iodophenyl isocyanate, 2,4-difluorophenyl isocyanate, 2-cyanophenyl isocyanate, 2-fluorophenethyl isocyanate, 2-thienyl isocyanate, 3,4-dichlorobenzyl isocyanate, 3,4-dichlorophenethyl isocyanate, 4-benzylphenyl isocyanate, 4-bromobenzyl isocyanate, 4-fluorobenzosulfonyl isocyanate, mPEG5K isocyanate, 3,5-dimethylisoxazol-4-yl isocyanate, 2-methoxy-5-methylphenyl isocyanate, 2-(4-biphenyl)ethyl isocyanate, 2-ethyl-6-methylphenyl isocyanate, 2-methyl-5-phenyl-3-furyl isocyanate, 1-(1-naphthyl)ethyl isocyanate, 3,4-(methylenedioxy)phenyl isocyanate, 2,3-dihydro-1-benzofuran-5-yl isocyanate, 4-methoxy-2-nitrophenyl isocyanate, 3,5-bis(trifluoromethyl)phenyl isocyanate, 4-(maleimido)phenyl isocyanate, 4-(dimethylamino)phenyl isocyanate, 3-(trifluoromethyl)phenyl isocyanate, 4-(chlorosulfonyl)phenyl isocyanate, 3-isopropenyl-α,α-dimethylbenzyl isocyanate, 3-chloro-4-methylphenyl isocyanate, 4-(trifluoromethyl)phenyl isocyanate, 2-(trifluoromethyl)phenyl isocyanate, 4,4′-oxybis(phenylisocyanate), 4-(chloromethyl)phenyl isocyanate, 4-chloro-3-(trifluoromethyl)phenyl isocyanate, 9H-fluoren-2-yl isocyanate, 2-(chloromethyl)phenyl isocyanate, 2-fluoro-5-(trifluoromethyl)phenyl isocyanate, 2-fluoro-3-(trifluoromethyl)phenyl isocyanate, 4-(benzyloxy)phenyl isocyanate, 4-fluoro-3-(trifluoromethyl)phenyl isocyanate, 4-fluoro-3-methylphenyl isocyanate, 3-fluoro-5-(trifluoromethyl)phenyl isocyanate, 4-chloro-2-fluorophenyl isocyanate, 5-fluoro-2-methylphenyl isocyanate, 2,3-dimethyl-6-nitrophenyl isocyanate, 2-(trifluoromethoxy)phenyl isocyanate, 2-fluoro-5-methylphenyl isocyanate, 4-(difluoromethoxy)phenyl isocyanate, 4-methyl-2-nitrophenyl isocyanate, 3-fluoro-2-methylphenyl isocyanate, 4-(trifluoromethylthio)phenyl isocyanate, 4-fluoro-2-(trifluoromethyl)phenyl isocyanate, 1-(4-fluorophenyl)ethyl isocyanate, 1-benzothiophen-5-yl isocyanate, 2-(difluoromethoxy)phenyl isocyanate, 2-(thien-2-yl)ethyl isocyanate, 2-bromo-4,6-difluorophenyl isocyanate, 2-chloro-4,6-dimethylphenyl isocyanate, 2-chloro-4-(trifluoromethyl)phenyl isocyanate, 2-chloro-4-(trifluoromethylthio)phenyl isocyanate, 2-chloro-5-methylphenyl isocyanate, 2-fluoro-4-iodophenyl isocyanate, 3-bromo-2,4,6-trimethylphenyl isocyanate, 3-chloro-2-fluorphenyl isocyanate, 3-chloro-2-methylphenyl isocyanate, 4-(trifluoromethyl)benzyl isocyanate, 4-bromo-2,6-difluorophenyl isocyanate, 4-bromo-2,6-dimethylphenyl isocyanate, 4-bromo-2-(trifluoromethyl)phenyl isocyanate, 4-bromo-2-chloro-6-methylphenyl isocyanate, 4-bromo-2-chloro-6-methylphenyl isocyanate, 4-bromo-2-ethylphenyl isocyanate, 4-chloro-2-phenoxyphenyl isocyanate, 4-ethoxy-2-nitrophenyl isocyanate, 4-fluoro-2-nitrophenyl isocyanate, 5-chloro-2-methylphenyl isocyanate, 5-chloro-2-phenoxyphenyl isocyanate, 5-methyl-2-nitrophenyl isocyanate, 5-phenyl-2-thienyl isocyanate, 6-fluoro-4H-1,3-benzodioxin-8-yl isocyanate, 9H-fluoren-9-yl isocyanate, benzyl isocyanate, ethyl isocyanate, trichloroacetyl isocyanate, 1-phenylethyl isocyanate, ethyl isocyanate formate, isocyanatophosphonic dichloride, 2-isocyanatoethyl methacrylate, 3-isocyanato-4-methoxybiphenyl, 2,4,6-trichlorophenyl isocyanate, triphenylsilyl isocyanate, 2,6-dibromo-4-ethylphenyl isocyanate, 2-chloro-4-nitrophenyl isocyanate, 2-tert-butyl-6-methylphenyl isocyanate, 4,4′-methylenebis(2-chlorophenyl isocyanate), 4,5-dimethyl-2-nitrophenyl isocyanate, 4-chloro-2-(trifluoromethyl)phenyl isocyanate, 4-chloro-2-nitrophenyl isocyanate, 1-isocyanato-2,3-dimethoxybenzene, 3-isocyanatopentane, isocyanatocyclobutane, isocyanato(methoxy)methane, ethyl (4-isocyanatophenyl)acetate, ethyl 4-(isocyanatomethyl)cyclohexanecarboxylate, 1,1-dimethoxy-2-isocyanatoethane, 1-chloro-3-fluoro-2-isocyanatobenzene, 2-chloro-3-fluorophenyl isocyanate, 2-isocyanato-3-methylbutyric acid methyl ester, 2-isocyanato-5-methylbenzonitrile, 5-chloro-2-isocyanatobenzonitrile, 5-ethyl-2-isocyanatobenzonitrile, 6-isocyanatohexanoic acid methyl ester, dimethyl 2-isocyanatoterephthalate, ethyl 2-isocyanato-4-methylvalerate, methyl 2-isocyanato-4-(methylsulfanyl)butanoate, methyl 2-isocyanato-4-methylpentanoate, ethyl isocyanatoacetate, phenyl isocyanatoformate, methyl 4-isocyanatobenzoate, methyl 3-isocyanatobenzoate, methyl isocyanatoformate, dimethyl 5-isocyanatoisophthalate and any desired mixtures of such monoisocyanates.

Thioisocyanates are likewise suitable. Preferred thioisocyanates are selected from the group consisting of 4-fluorobenzyl isothiocyanate, dibutyltin diisothiocyanate, 2,6-difluorophenyl isothiocyanate, 3-cyanophenyl isothiocyanate, 3-nitrophenyl isothiocyanate and phenyl isocyanate.

Likewise suitable are mono- or polyisocyanates obtained by the modification of monomeric isocyanates as described hereinabove in the present application.

### Prepolymers

Isocyanate-terminated prepolymers suitable for the production of the polymerizable composition are obtained by reaction of an alcohol, an amine or a thiol with a polyisocyanate. A molar excess of isocyanate groups to isocyanate-reactive groups must be present.

Suitable alcohols are mono- or polyhydric monomeric alcohols, preferably selected from the group consisting of hexanol, butanediol.

Preferred as the isocyanate for the production of the isocyanate-bearing prepolymer are HDI in monomeric form, oligomerized HDI and mixtures thereof.

It is particularly preferable when the proportion of mono- and polyisocyanates having aromatically bonded isocyanate groups in the polyisocyanate component A is not more than 50% by weight, more preferably not more than 25% by weight, yet more preferably not more than 10% by weight and most preferably not more than 5% by weight.

### Trimerization Catalyst B

The trimerization catalyst B is a carboxylate having an appropriate counterion. Certain trimerization catalysts B are advantageously combined with catalyst solvents and/or complex formers.

Carboxylates where the corresponding acid has a pKₐ of 3.5 to 5.0 are preferred. It is more preferable when the pKₐ is in the range from 4.0 to 5.0. The pKₐ is most preferably in the range from 4.2 to 4.8. Said carboxylates are especially salts of acetic acid, caproic acid, formic acid (pKa 3.77), acrylic acid (4.25), benzoic acid (4.2), 3-chlorobenzoic acid (3.83), 4-chlorobenzoic acid (3.99), anisic acid [4-methoxybenzoic acid] (4.47), fumaric acid (first 3.02 and second 4.38), tartaric acid (2.98 and 4.34), succinic acid (4.16 and 5.61), propionic acid (4.87), butyric acid (4.82), valeric acid (4.84), isobutyric acid (4.86), 2-ethylhexanoic acid (4.82), 2-ethylbutyric acid (4.73), 2-methylbenzoic acid (3.89), 3,3-dimethylglutaric acid (3.70 and 6.34), 3,4,5-trihydroxybenzoic acid (4.40), 3,4-dihydroxybenzoic acid (4.48), 3,5-dihydroxybenzoic acid (4.04), 3-bromobenzoic acid (3.85), 3-chlorobutyric acid (4.05), 3-chlorocrotonic acid (3.84), 3-chloroisocrotonic acid (4.05), 3-chloropropionic acid (3.98-4.10), 3-hydroxybenzoic acid (4.12), 3-mercaptopropionic acid (4.34), 3-methylbenzoic acid (4.28), 3-nitropropionic acid (3.8), 4,4,4-trifluorobutyric acid (4.15), 4,4,5,5,6,6,6-heptafluorohexanoic acid (4.18), 4-bromobenzoic acid (4.18), 4-chlorobutyric acid (4.52), 4-methylbenzoic acid (4.35), 4-phenylbutyric acid (4.76), 5,5,5-trifluoropentanoic acid (4.49), acetoacetic acid (3.58), aceturic acid (3.64), adipic acid (4.43 and 5.52), allocinnamic acid (3.96), angelic acid (4.30), anthracene-1-carboxylic acid (3.69), anthracene-9-carboxylic acid (3.65), anthranilic acid (5.00), atropic acid (3.84), azelaic acid (4.54 and 5.52), barbituric acid (4.00), bromosuccinic acid (2.55 and 4.4), camphoric acid (4.64), caprylic acid (4.85), quinic acid (3.56), chlorofumaric acid (1.78 and 3.81), chloromaleic acid (1.72 and 3.86), citric acid (3.13 and 4.76 and 6.4), crotonic acid (4.7), cyanic acid (3.66), cyclobutanecarboxylic acid (4.74), cis-cyclohexane-1,4-dicarboxylic acid (4.52 and 5.52), cyclohexanecarboxylic acid (4.89), cyclohexylacetic acid (4.64), cyclohexylpropionic acid (4.87), cyclopropanecarboxylic acid (4.84), aspartic acid (3.68 and 9.46), diclofenac (4.00), diglycolic acid (2.96 and 4.43), flufenaminic acid (3.90), glutaric acid (4.33 and 5.57), glycolic acid (3.83), hydratropic acid (4.38), hydroperoxyl (4.70), hydrocinnamic acid (4.67), isocrotonic acid (4.44), isovaleric acid (4.76), isovanillic acid (4.49), itaconic acid (3.82 and 5.55), suberic acid (4.52 and 5.52), ascorbic acid (4.2), malic acid (3.41 and 4.86), levulinic acid (4.59), m-chlorocinnamic acid (4.29), mefenamic acid (4.2), mesitylenic acid (4.32), mesotartaric acid (3.2 and 4.82), lactic acid (3.87), naphthalene-1-carboxylic acid (3.7), naphthalene-2-carboxylic acid (4.15), o-chlorocinnamic acid (4.42), oxalic acid (1.46 and 4.4), p-chlorocinnamic acid (4.41), pelargonic acid (4.96), phenylacetic acid (4.35), phthalamic acid (3.8), pimelic acid (4.47 and 5.52), sebacic acid (4.55 and 5.52), shikimic acid (4.15), sorbic acid (4.8), tartronic acid (2.3 and 4.98), terephthalic acid (3.82), thioglycolic acid (3.55 and 6.00), trans-diphenylacrylic acid (4.8), vanillic acid (4.53), veratric acid (4.44), vinylacetic acid (4.31), violuric acid (4.57), cinnamic acid (4.44), enanthic acid (4.89)

Particularly preferred are salts of acetic acid, caproic acid, formic acid, acrylic acid, benzoic acid, propionic acid, butyric acid, valeric acid, isobutyric acid and 2-ethylhexanoic acid.

In a particular embodiment preference is also given to those catalysts present in the form of zwitterions having a pKa in a preferred range. Examples include: 2-hydroxybutyric acid (4.04), 4-aminobutyric acid (4.54), 2-aminobenzoic acid (4.97), 3-aminobenzoic acid (4.78-4.92), 4-aminobenzoic acid (4.93).

Preferred metal ions are alkali metal ions, alkaline earth metal ions, ions of transition group metals and tin ions.

It is preferable when the carboxylate is combined with phosphonium, ammonium or metal ions as counterions.

Preferred alkali metal ions are Li⁺, Na⁺ and K⁺. Preferred alkaline earth metal ions are Mg²⁺, Ca²⁺, Sr²⁺ and Ba²⁺.

Preferred ions of transition group metals are Fe²⁺, Zn²⁺, Cu²⁺, Ti²⁺, Zr²⁺, Yr²⁺.

Those skilled in the art are aware that the effect of CO₂ on the curing time of the reaction mixture depends on the type and concentration of the employed trimerization catalyst B. When a catalyst of a certain activity is used in very small amounts it is to be expected that even at low CO₂ content at room temperature the reaction mixture remains liquid for a very long time and an effect of CO₂ on the reactivity of the system is no longer detectable on account of the slow reaction. The catalyst concentration may be so low that curing does not take place even at elevated temperature. In a preferred embodiment of the present invention the concentration of the employed trimerization catalyst B or a mixture of two or more trimerization catalysts B is therefore at least high enough to ensure that at temperatures of at least 150° C. the reaction mixture reaches the gel point within not more than 20 minutes. The gel point is reached when the modulus for G′ (Pa) reaches or exceeds the modulus for G″ (Pa) measured in oscillation at 23° C., 1/s, 1% amplitude in a plate-plate rheometer.

Conversely the use of very high catalyst concentrations can also negate the effect of the present invention. If the catalyst concentration is high enough the reaction mixture reaches the gel point within minutes or even seconds even at room temperature without the addition of CO₂ having an appreciable influence on this period.

In a preferred embodiment of the present invention the concentration of a trimerization catalyst B or a mixture of two or more trimerization catalysts B present in the reaction mixture according to the invention is therefore defined in functional terms. It is measured such that at 23° C. and a CO₂ concentration of not more than 90 ppm the reaction mixture reaches the gel point within 1 to 22 hours, preferably 6 to 22 hours. For a particular catalyst this concentration range may be determined by a simple series of experiments.

For the present application the time until reaching the gel point, the gel time, is identical to the pot life since the mixture can then no longer be used by pouring and brushing. In analytically simplified terms said gel time may be determined with so-called gel timers via the viscosity increase.

In a preferred embodiment of the present invention the polymerizable composition additionally contains a polyol and/or a polyether which promotes the solvation of the cation, preferably a polyether. Preferred polyethers are selected from the group consisting of crown ethers, diethylene glycol, polyethylene glycols and polypropylene glycols. It has been found to be particularly useful to employ a polyethylene glycol or a crown ether, particularly preferably 18-crown-6 or 15-crown-5. The crown ethers are preferably selected such that they effect good complexation of the metallic cation that is the counterion to the preferred carboxylate catalyst. Those skilled in the art can determine suitable crown ethers for the respectively employed metal ion from the literature. Polyethylene glycols having a number-average molecular weight of 100 to 1000 g/mol, preferably 300 g/mol to 500 g/mol and in particular 350 g/mol to 450 g/mol are preferred.

The polymerizable composition according to the invention may in principle contain further compounds that catalyze the crosslinking of isocyanate groups with one another. However, when the polymerizable composition is admixed with compounds that already show an appreciable catalytic activity at temperatures below 80° C. the presence thereof negates the advantages of the present invention. The mass fraction thereof in the polymerizable composition must therefore be limited.

It is preferable when the mass fraction of all compounds distinct from trimerization catalyst B in the context of the present invention and which catalyze the reaction of isocyanate groups to afford isocyanurate, biuret, uretdione, iminooxadiazinedione or oxiadiazonetrione structures even at temperatures below 80° C. is limited to an amount that does not reduce the pot life of the polymerizable composition to below the limits specified hereinbelow in the present application. Since different compounds have a different specific catalyst activity the precise maximum tolerable mass fraction depends on the respective compound. However, in principle the mass fraction of the abovementioned compounds must not exceed 20% by weight, preferably 10% by weight and most preferably 5% by weight based on the total amount of all carboxylates having the properties according to the invention.

### CO₂ Content

According to the invention the CO₂ content of the polymerizable composition according to the invention is at least 150 ppm based on the total amount of the liquid constituents of the polymerizable composition. The minimum content of CO₂ is more preferably at least 200 ppm, yet more preferably at least 250 ppm and most preferably at least 300 ppm.

For the abovementioned values it must be noted that they assume that a CO₂-saturated polyisocyanate based on HDI for example has a CO₂ content of 410 ppm. This corresponds to the solubility measured in an HDI-based polyisocyanate having the below-defined parameters at 23° C. and standard pressure. When determining the CO₂ content of reaction mixtures and polyisocyanates the measured values are therefore normalized to the value for a CO₂-saturated solution defined as 410 ppm. All CO₂ values reported in the present application could therefore also be regarded as relative contents based on a CO₂-saturated system. A measured value of 205 ppm thus corresponds to 50% of the saturation achievable in an air atmosphere at standard pressure. The threshold value of 150 ppm defined in the claims thus corresponds to 37% of this saturation. All further CO₂ values reported in this patent application may correspondingly be converted into a percentage of the achievable saturation in an air atmosphere at standard pressure. Since different methods of CO₂ measurement could potentially result in different ppm values for the same sample this approach makes it possible to achieve reproducibility.

The exemplary embodiments show that the CO₂ content of a polymerizable composition may be adjusted in various ways. CO₂ may be added in frozen form as dry ice. It is likewise possible to pass gaseous CO₂ through a liquid. The CO₂ may in principle be dissolved in one or more of the components of the polymerizable composition before mixing with the other components. The polyisocyanate component A is preferred here since it has the greatest volume fraction. However, it is likewise possible to initially produce the polymerizable composition by combining the components thereof and shortly thereafter, preferably not more than 30 minutes after addition of all components with the exception of the CO₂, adjust the CO₂ concentrations according to the invention. Whether the complete mixing of the components is carried out before or after addition of the CO₂ is immaterial here.

In a particular embodiment CO₂ is produced in situ by addition of a compound such as for example water.

### Filler C

In a particularly preferred embodiment of the present invention the polymerizable composition contains at least one filler F. Said filler may be organic or inorganic and may be present in any shape and size known to those skilled in the art.

Preferred organic fillers are wood, pulp, paper, paperboard, fabric slivers, cork, wheat chaff, polydextrose, cellulose, aramids, polyethylene, carbon, carbon nanotubes, polyester, nylon, Plexiglass, flax, hemp and also sisal.

Preferred inorganic fillers are AlOH₃, CaCO₃, silicon dioxide, magnesium carbonate, TiO₂, ZnS, minerals containing silicates, sulfates, carbonates and the like, such as magnesite, baryte, mica, dolomite, kaolin, talc, clay minerals, and carbon black, graphite, boron nitride, glass, basalt, boron, ceramic and silica.

In a particularly preferred embodiment of the present invention the polymerizable composition according to the invention contains a fibrous filler C consisting of organic fibers, inorganic fibers or mixtures thereof.

Preferred inorganic fibers are glass fibers, basalt fibers, boron fibers, ceramic fibers, whiskers, silica fibers and metallic reinforcing fibers. Preferred organic fibers are aramid fibres, polyethylene fibers, carbon fibers, carbon nanotubes, polyester fibers, nylon fibers and Plexiglas fibers. Preferred natural fibers are flax fibers, hemp fibers, wood fibers, cellulose fibers and sisal fibers.

### Advantages

Compared to the otherwise identical compositions having a lower CO₂ content the polymerizable composition according to the invention exhibits a markedly slower viscosity increase. Nevertheless, rapid curing remains possible after temperature elevation. This extends the period in which a ready to use composition may be stored (pot life, wherein the pot life was in the present case determined by the gel time measured with a gel timer by the method reported hereinbelow. This effect also contributes to the avoidance of waste since a relatively high proportion of the composition may be utilized as intended and a relatively small proportion must be disposed of after exceeding a critical viscosity. The present invention thus provides ecological and economic advantages.

The polymerizable composition according to the invention has a gel time which is at least doubled compared to otherwise identical polymerizable compositions whose CO₂ content is below 100 ppm. It is particularly preferable when a polymerizable composition having a CO₂ content of at least 300 ppm has a gel time which is at least doubled compared to an otherwise identical polymerizable composition having a CO₂ content of not more than 100 ppm. It is very particularly preferable when this effect is observable upon comparison of a polymerizable composition having a CO₂ content of at least 380 ppm with an otherwise identical polymerizable composition having a CO₂ content of not more than 100 ppm.

The study underlying the present application has especially shown that polymerizable compositions containing aliphatic polyisocyanates remain liquid for at least 24 hours. In some cases there formed at the surface a layer of polymerized material of not more than 2 mm in thickness which is attributable to the reaction of isocyanates with atmospheric moisture to afford polyureas. However, the material underneath remained usable. By contrast, the polymerizable composition having a CO₂ content of 88 ppm employed in comparative test 13 had gelled after 24 hours and was therefore unusable.

### Use of CO₂

In a further embodiment the present invention relates to the use of CO₂ to increase the gel time of a polymerizable composition having a molar ratio of isocyanate groups to isocyanate-reactive groups of at least 1.5:1.0 containing
a) a polyisocyanate composition A containing at least 1% by weight of isocyanate groups; and
b) at least one trimerization catalyst B which is a carboxylate.

The use according to the invention preferably consists of addition of at least 150 ppm of CO₂ based on the total amount of the liquid constituents of the polymerizable composition. The addition more preferably comprises at least 200 ppm, yet more preferably at least 250 ppm and most preferably at least 300 ppm of CO₂.

### Use of the Polymerizable Composition

In yet a further embodiment the present invention relates to the use of the polymerizable composition according to the invention for producing a polymer.

This use is preferably characterized by an increase in the temperature of the polymerizable composition to 80° C. to 300° C. This temperature is maintained until the polymerizable composition is cured, preferably for at least 5 minutes. The use according to the invention is particularly preferably characterized in that during production of the polymer at least 80% of the isocyanate groups originally present in the polymerizable composition are converted. Conversely, this means that the content of free isocyanate groups in the polymer is not more than 20% of the isocyanate groups originally present in the polymerizable composition. The resulting polymer is preferably a polymer formed by crosslinking of isocyanate groups to afford isocyanurate groups. However, the formation of further groups, in particular biuret, uretdione, iminooxadiazinedione, oxadiazinetrione, urethane and allophanate groups is not excluded.

### Process I

In yet a further embodiment the present invention relates to a process for producing a polymer comprising the process steps of
a) providing a reaction mixture which contains (i) a polyisocyanate composition A containing at least 1% by weight of isocyanate groups, (ii) at least one trimerization catalyst B which is a carboxylate and (iii) at least 150 ppm of CO₂ based on the total amount of the liquid constituents in the polymerizable composition; and
b) curing the reaction mixture at a temperature between 80° C. and 300° C.

All abovementioned definitions for the constituents of the reaction mixture recited hereinabove also apply to this embodiment.

It is preferable when the polyisocyanate composition A consists of oligomeric polyisocyanates to an extent of at least 80% by weight, more preferably at least 90% by weight.

It is further preferable when the curing in process step b) has the result that at least 80% of the isocyanate groups originally present in the polyisocyanate composition A are converted.

It is further preferable when the reaction mixture is stored at a temperature between 10° C. and 40° C. for least 2 hours and more preferably at least 4 hours between the providing in process step a) and the curing in process step b). The abovementioned storage duration is particularly preferably not more than 20 hours.

### Process II

In yet a further embodiment the present invention relates to a process for producing a polymerizable composition having an elevated gel time, wherein a polyisocyanate composition A, a catalyst composition containing a trimerization catalyst B and CO₂ are combined, characterized in that
a) the CO₂ concentration achieved in the polymerizable composition is at least 150 ppm based on the total amount of the polymerizable composition; and
b) isocyanate-reactive compounds are employed only in an amount such that in the polymerizable composition a molar ratio of isocyanate groups to isocyanate-reactive groups of at least 1.5:1.0 is achieved.

Suitable processes for introduction of CO₂ into a liquid are disclosed hereinabove in the present application.

All other abovementioned definitions are likewise applicable to this embodiment. As recited hereinabove the CO₂ may be present in one of the components to be employed for producing the polymerizable composition, preferably the polyisocyanate composition. However, it is also possible to initially mix the polyisocyanate composition A and the catalyst composition B and subsequently, preferably within not more than 30 minutes after addition of the two components to one another, add the CO₂.

A distinction is made here between combining components with one another and mixing thereof. After addition the components are entirely in one vessel. However, they need not necessarily already form a homogeneous mixture. By contrast, a homogeneous mixture is present after mixing. In order to realize the advantages of the invention it is preferable when no later than 30 minutes after the combining of the catalyst composition and the polyisocyanate composition A a homogeneous mixture of these two components having the above-defined minimum content of CO₂ is present.

When gaseous CO₂ is added, combining and mixing coincide. When CO₂ is added in the form of dry ice, a subsequent mixing thereof with the liquid, for example by stirring, is preferred.

In yet a further embodiment the present invention relates to the use of the above-defined process for producing composite materials, potting compounds, coatings, adhesives or three-dimensional printed components.

The working examples which follow serve merely to illustrate the invention. They are not intended to limit the scope of protection of the claims in any way.

### EXAMPLES

### General Information:

Unless otherwise stated all reported percentage values are in percent by weight (% by weight).

The ambient temperature of 23° C. at the time of performing the experiment is referred to as RT (room temperature).

The methods specified hereinbelow for determining the corresponding parameters were used for performing and evaluating the examples and are also the methods for determining the parameters relevant according to the invention in general.

### Determination of Phase Transitions by DSC

The phase transitions were determined by means of DSC (differential scanning calorimetry) with a Mettler DSC 12E (Mettler Toledo GmbH, Giessen, Germany) in accordance with DIN EN 61006. Calibration was effected via the melt onset temperature of indium and lead. 10 mg of substance were weighed out in standard capsules. The measurement was effected by three heating runs from −50° C. to +200° C. at a heating rate of 20 K/min with subsequent cooling at a cooling rate of 320 K/min. Cooling was effected by means of liquid nitrogen. The purge gas used was nitrogen. The reported values are in each case based on evaluation of the 1st heating curve since in the investigated reactive systems, changes in the sample are possible in the measuring process at high temperatures as a result of the thermal stress in the DSC. The glass transition temperature T_{g} was obtained from the temperature at half the height of a glass transition step.

### Determination of Infrared Spectra

The infrared spectra were measured on a Bruker FT-IR spectrometer equipped with an ATR unit.

### Acid Number Determination

Acid number was determined using method according to DIN ISO 2114.

### Gel Time Determination

Gel time was determined using the instrument Geltimer GT-SP 100.50 from Gelnorm with measurement pins made of steel and a length of L=150 mm.

### Determination of Carbon Dioxide Content

To determine the CO₂ content of a sample this was examined according to DIN EN ISO/IEC 17025. The specified samples were analyzed under identical conditions by gas chromatography. A sample stored for 4 weeks in an air atmosphere having a measured CO₂ content of 410 ppm was used as a reference sample.

All other samples were related to the comparative sample using mass-selective evaluation.

### Starting Compounds

Polyisocyanate A1: HDI trimer (NCO functionality >3) having an NCO content of 23.0% by weight from Covestro AG. It has a viscosity of about 1200 mPa-s at 23° C. (DIN EN ISO 3219/A.3).
Polyisocyanate A2: HDI/IPDI polyisocyanate having an NCO content of 21.0% by weight from Covestro AG. It has a viscosity of about 22 500 mPa-s at 23° C. (DIN EN ISO 3219/A.3).
Potassium acetate was obtained in a purity of >99% by weight from ACROS.
Polyethylene glycol (PEG) 400 was obtained in a purity of >99% by weight from ACROS.
Zinc stearate having a zinc proportion of 10-12% was obtained from Sigma-Aldrich.
The release agent INT-1940 RTM was obtained from AXEL PLASTICS.
Catalyst K1 is a mixture of 10-30% potassium 2-ethylhexanoate in ethylene glycol and diethylene glycol from Evonik Industries AG.
Glass fiber mat: A P-D INTERGLAS TECHNOLOGIES GmbH 90070 (US Type 1610) plain weave glass fiber mat having a weight of 82 g/m² was used.
All raw materials except for the catalyst were degassed under reduced pressure prior to use, and the polyethylene glycol was additionally dried.

### Production of Catalyst K2:

Potassium acetate (5.0 g) was stirred in the PEG 400 (95.0 g) at RT until all of it had dissolved. This afforded a 5% by weight solution of potassium acetate in PEG 400 which was used as catalyst without further treatment.

### Production of the Reaction Mixture

Unless otherwise stated the polyisocyanurate composites were produced by first producing the isocyanate composition by mixing the appropriate isocyanate components (A1 or A2) with an appropriate amount of catalyst (K1-K2) and additives at 23° C. in a Speedmixer DAC 150.1 FVZ from Hauschild at 1500 rpm for 120 seconds.

A portion of the mixture was then transferred into a mold (metal lid, about 6 cm in diameter and about 1 cm in height) and cured in an oven.

The remainder of the mixture was investigated for gel time using a gel timer.

### Working Example 1

A resin mixture composed of degassed polyisocyanate A1 (85.0 g), catalyst K2 (3.64 g), zinc stearate (0.23 g), INT-1940RTM (2.04 g) and dry ice (9.09 g) was produced as described hereinabove (acid number: 27.4 mg KOH/g). Curing in the oven afforded a solid material having a T_{g} of 98° C. Thermal curing reduced the height of the characteristic NCO band between 2300 to 2250 cm⁻¹ by at least 80%. The gel time of the resin mixture at room temperature was more than 22 hours. After 24 h of open storage at room temperature a liquid material having a gelled film on its surface was obtained.

### Working Example 2

A resin mixture composed of degassed polyisocyanate A1 (44.52 g), catalyst K2 (3.81 g), zinc stearate (0.24 g), INT-1940RTM (2.14 g) and a previously produced mixture of degassed polyisocyanate A1 (44.52 g) and dry ice (4.77 g) was produced as described hereinabove. Curing in the oven afforded a solid material having a T_{g} of 88° C. Thermal curing reduced the height of the characteristic NCO band between 2300 to 2250 cm⁻¹ by at least 80%. The gel time of the resin mixture at room temperature was more than 22 hours. After 24 h of storage at room temperature a liquid material having a gelled film on its surface was obtained.

### Working Example 3

A resin mixture composed of degassed polyisocyanate A1 (29.22 g), catalyst K2 (3.75 g), zinc stearate (0.23 g), INT-1940RTM (2.11 g) and a previously produced mixture of degassed polyisocyanate A1 (58.44 g) and dry ice (6.25 g) was produced as described hereinabove. Curing in the oven afforded a solid material having a T_{g} of 93° C. Thermal curing reduced the height of the characteristic NCO band between 2300 to 2250 cm⁻¹ by at least 80%. The gel time of the resin mixture at room temperature was more than 22 h. After 24 h of storage at room temperature a liquid material having a gelled film on its surface was obtained.

### Working Example 4

A resin mixture composed of degassed polyisocyanate A1 (60.32 g), catalyst K2 (3.87 g), zinc stearate (0.24 g), INT-1940RTM (2.18 g) and a previously produced mixture of degassed polyisocyanate A1 (30.16 g) and dry ice (3.23 g) was produced as described hereinabove. Curing in the oven afforded a solid material having a T_{g} of 86° C. Thermal curing reduced the height of the characteristic NCO band between 2300 to 2250 cm⁻¹ by at least 80%. The gel time of the resin mixture at room temperature was more than 22 hours. After 24 h of storage at room temperature a liquid material having a gelled film on its surface was obtained.

### Working Example 5

A resin mixture composed of freshly opened polyisocyanate A1 (93.5 g) (CO₂ content: 88 ppm), catalyst K2 (4.0 g), zinc stearate (0.25 g), INT-1940RTM (2.25 g) and dry ice (0.5 g) was produced as described hereinabove (CO₂ content of mixture: 426 ppm). The gel time of the resin mixture at room temperature was more than 22 hours. After 24 h of storage at room temperature a liquid material having a gelled film on its surface was obtained.

### Working Example 6

A resin mixture composed of freshly opened polyisocyanate A1 (93.5 g), catalyst K2 (4.0 g), zinc stearate (0.25 g), INT-1940RTM (2.25 g) and dry ice (1.0 g) was produced as described hereinabove. The gel time of the resin mixture at room temperature was more than 22 hours. After 24 h of storage at room temperature a liquid material having a gelled film on its surface was obtained.

### Working Example 7

Freshly opened polyisocyanate was left open for 24 hours at room temperature. A resin mixture composed of the polyisocyanate A1 stored open at room temperature for 24 h (93.5 g), catalyst K2 (4.0 g), zinc stearate (0.25 g) and INT-1940RTM (2.25 g) was produced as described hereinabove. (CO₂ content: 410 ppm, acid number: 25.7 mg KOH/g). The gel time of the resin mixture at room temperature was more than 22 hours. After 24 h of storage at room temperature a liquid material having a gelled film on its surface was obtained.

### Working Example 8

A resin mixture composed of degassed polyisocyanate A2 (93.5 g), catalyst K2 (4.0 g), zinc stearate (0.25 g), INT-1940RTM (2.25 g) and dry ice (0.5 g) was produced as described hereinabove. Curing in the oven afforded a solid material having a T_{g} of 148° C. Thermal curing reduced the height of the characteristic NCO band between 2300 to 2250 cm⁻¹ by at least 80%. The gel time of the resin mixture at room temperature was more than 22 hours. After 24 h of storage at room temperature a liquid material having a gelled film on its surface was obtained.

### Working Example 9

A resin mixture composed of degassed polyisocyanate A1 (95.0 g), catalyst K1 (1.0 g), zinc stearate (0.25 g), INT-1940RTM (2.25 g) and dry ice (0.5 g) was produced as described hereinabove. Curing in the oven afforded a solid material having a T_{g} of 98° C. Thermal curing reduced the height of the characteristic NCO band between 2300 to 2250 cm⁻¹ by at least 80%. The gel time of the resin mixture at room temperature was more than 22 hours. After 24 h of storage at room temperature a liquid material having a gelled film on its surface was obtained.

### Working Example 10

A resin mixture composed of freshly opened polyisocyanate A1 (93.5 g), zinc stearate (0.25 g) and INT-1940RTM (2.25 g) was produced as described hereinabove. The mixture was then stirred uncovered at 1500 rpm for 10 min with a dissolver. The catalyst K2 (4.0 g) was then added and the mixture stirred again uncovered at 1500 rpm for 10 min with a dissolver. The gel time of the resin mixture at room temperature was more than 22 hours. After 24 h of storage at room temperature a liquid material having a gelled film on its surface was obtained.

### Working Example 11

A resin mixture composed of freshly opened polyisocyanate A1 (93.5 g) (CO₂ content: 88 ppm, acid number: 24.5 mg KOH/g), catalyst K2 (4.0 g), zinc stearate (0.25 g), INT-1940RTM (2.25 g) and dry ice (0.1 g) was produced as described hereinabove (CO₂ content of mixture: 388 ppm). The gel time of the resin mixture at room temperature was more than 22 hours. After 24 h of storage at room temperature a liquid material having a slightly elevated viscosity was obtained.

### Comparative Example 12

A resin mixture composed of degassed polyisocyanate A1 (93.5 g), catalyst K2 (4.0 g), zinc stearate (0.25 g) and INT-1940RTM (2.25 g) was produced as described hereinabove. Curing in the oven afforded a solid material having a T_{g} of 93° C. Thermal curing reduced the height of the characteristic NCO band between 2300 to 2250 cm⁻¹ by at least 80%. The gel time of the resin mixture at room temperature was less than 22 hours. After 24 hours of storage at room temperature a fully gelled material was obtained.

### Comparative Example 13

A resin mixture composed of freshly opened polyisocyanate A1 (93.5 g) (CO₂ content: 88 ppm, acid number: 24.5 mg KOH/g), catalyst K2 (4.0 g), zinc stearate (0.25 g) and INT-1940RTM (2.25 g) was produced as described hereinabove. Curing in the oven afforded a solid material having a T_{g} of 93° C. Thermal curing reduced the height of the characteristic NCO band between 2300 to 2250 cm⁻¹ by at least 80%. The gel time of the resin mixture at room temperature was 4 hours 40 min. After 24 h of storage at room temperature a fully gelled material was obtained.

### Comparative Example 14

A resin mixture composed of degassed polyisocyanate A2 (93.5 g), catalyst K2 (4.0 g), zinc stearate (0.25 g) and INT-1940RTM (2.25 g) was produced as described hereinabove. Curing in the oven afforded a solid material having a T_{g} of 149° C. Thermal curing reduced the height of the characteristic NCO band between 2300 to 2250 cm⁻¹ by at least 80%. The gel time of the resin mixture at room temperature was less than 22 hours. After 24 hours of storage at room temperature a fully gelled material was obtained.

1. A polymerizable composition having a molar ratio of isocyanate groups to isocyanate-reactive groups of at least 1.5:1.0 comprising:
a) a polyisocyanate composition A comprising at least 1% by weight of NCO, wherein polyisocyanates present in the polyisocyanate composition A consist of oligomeric polyisocyanates to an extent of at least 80% by weight;
b) at least one trimerization catalyst B which is a carboxylate; and
c) at least 150 ppm of CO₂ based on a total amount of liquid constituents of the polymerizable composition.

2. The polymerizable composition as claimed in claim 1, wherein the carboxylate comprises a phosphonium, ammonium, or metal ion as a counterion.

3. The polymerizable composition as claimed in claim 1, wherein the carboxylate has a pKa value of at least 3.5 and at most 5.0.

4. The polymerizable composition as claimed in claim 1, wherein the polyisocyanates consist of oligomeric polyisocyanates comprising biuret groups to an extent of not more than 20% by weight.

5. The polymerizable composition as claimed in claim 1, wherein a proportion of mono- and polyisocyanates having aromatically bonded isocyanate groups in the polyisocyanate component A is not more than 50% by weight.

6. The polymerizable composition as claimed in claim 1, wherein at 23° C. and a CO₂ concentration of not more than 90 ppm a combination of polyisocyanate composition A and trimerization catalyst B reaches a gel point within 1 to 22 hours.

7. (canceled)

8. (canceled)

9. (canceled)

10. A process for producing a polymerizable composition having an elevated pot life, comprising combining a polyisocyanate composition A, a catalyst composition comprising a trimerization catalyst B which is a carboxylate, and CO₂, wherein the polyisocyanates present in the polyisocyanate composition A comprise oligomeric polyisocyanates to an extent of at least 80% by weight, wherein
a) the CO₂ concentration achieved in the polymerizable composition is at least 150 ppm based on a total amount of liquid constituents of the polymerizable composition; and
b) isocyanate-reactive compounds are employed only in an amount such that in the polymerizable composition a molar ratio of isocyanate groups to isocyanate-reactive groups of at least 1.5:1.0 is achieved.

11. The process as claimed in claim 10, wherein upon reaching the CO₂ concentration at least 150 ppm the pot life of the polymerizable composition is at least twice as long as for a CO₂ concentration of not more than 90 ppm.

12. The process as claimed in claim 10, wherein the CO₂ concentration of the polymerizable composition is reached by using a polyisocyanate composition A having a suitable CO₂ content.

13. The process as claimed in claim 10, wherein the CO₂ concentration of the polymerizable composition is established by addition of CO₂ to the polymerizable composition after addition of the polyisocyanate composition A and the catalyst composition to one another.

14. The process as claimed in claim 10, further comprising producing a composite material, a potting compound, a coating, an adhesive, or a three-dimensional printed component, at least in part, from the polymerizable composition.

15. A process for producing a polymer comprising:
a) providing a reaction mixture comprising (i) a polyisocyanate composition A containing at least 1% by weight of isocyanate groups, (ii) at least one trimerization catalyst B which is a carboxylate and (iii) at least 150 ppm of CO₂ based on a total amount of liquid constituents in the polymerizable composition; and
b) curing the reaction mixture at a temperature between 80° C. and 300° C.
